(19) United States
(12) Patent Application Publication
(10) Pub. No.: US 2010/0129559 A1
(43) Pub. Date: May 27, 2010

(54) ADJUSTABLE ROLLER APPARATUS FOR SPREADING SUBSTANCES

(75) Inventors: Abderrahmane Dermoune, Sherbrooke (CA); Roger Paradis, Mont St-Hilaire (CA); Abdelaziz Bourega, Sherbrooke (CA); Jean-Pierre Dionne, Montreal (CA)

Correspondence Address: Anglehart et al., Suite 258, 393 St-Jacques, Montreal, QC, H2Y 1N9, CA

(73) Assignee: GVL CANADA INC., Montreal, QC (CA)

(21) Appl. No.: 12/446,399

(22) PCT Filed: Oct. 19, 2007
(86) PCT No.: PCT/CA2007/001857

§ 371 Date: Feb. 1, 2010

Related U.S. Application Data
(60) Provisional application No. 60/862,294, filed on Oct. 20, 2006.

(30) Foreign Application Priority Data
Oct. 20, 2006 (CA) PCT/CA2007/001052

(51) Int. Cl. B05D 1/40; B05C 5/02; F16C 13/00

(52) U.S. Cl. 427/424; 118/300; 100/155 R

(57) ABSTRACT

There is provided a system for spreading a substance. The system comprises a at least two rotating means disposed in a housing. The rotating means are adapted to compress and move said substance. The system permits to control the thickness of the substance to be spread through the outlet. Methods for spreading a substance are also provided.

### TECHNICAL FIELD

The present invention relates to methods and systems for spreading a substance. For example, such a spreading can be made in such a manner to obtain a predetermined thickness. There is also provided methods and systems for feeding apparatuses which require the spreading out of a substance on a predetermined thickness. These methods and systems can be used in various applications. They can be used, for example, in order to provide a uniform distribution and conditioning of spreadable substance at a predetermined thickness along a desired width. These systems can be combined with any apparatuses that require a substance conditioning and spreading at a predetermined thickness. These methods and systems can operate continuously or as a batch process.

### BACKGROUND OF THE INVENTION

Currently, in paste industry and bakeries, use is made of conventional systems which allow the stretching of the dough and the reduction of its thickness. Dough is a fluid material with a high viscosity and elasticity due to its gel structure.

However, such conventional systems cannot be used with substances of low viscosity, for example sludges, composed of blocks of various sizes, and requiring a compaction, a spreading out on a predetermined thickness, in a continuous and regular way.

### SUMMARY OF THE INVENTION

According to an aspect of the invention, there is provided a system for spreading a substance. The system comprises:
a housing adapted to receive the substance and comprising an inlet and an outlet; and
at least two rotating means disposed in the housing and adjacently to the outlet, the rotating means being adapted to compress and move the substance to the outlet, one of the rotating means being closer to the outlet than at least one other of the rotating means, the system being adapted to move the rotating means which is closer to the outlet essentially along an axis and to adjust it so as to control the thickness of the substance to be spread through the outlet.

The rotating means closer to the outlet can be restricted to move along the axis. The rotating means can be adapted to receive therebetween the substance to be spread. Such rotating means can be rollers and can be moved at a same speed. The system can also further comprise at least two other rollers disposed between the inlet and the rollers disposed adjacently to the outlet. The at least two other rollers can be rotated substantially at a same speed and adapted to receive therebetween the substance to be spread through the outlet. The system can also further comprise adjustment means permitting to adjust the distance between two adjacent rollers disposed so as to control the pressure applied to the substance passing therebetween. For example, the distance between the at least two other rollers can be greater than the distance between the rollers disposed adjacently to the outlet. The rollers and the other rollers can define, therebetween, a volume which allows for compaction of the substance and to increase its density.

In accordance with one embodiment, each of the rollers can be rotated according to a predetermined speed. In another embodiment, the at least two rollers can be rotated according to a predetermined speed and the at least two other rollers can be rotated to another predetermined speed. At least one of the rollers can be powered by a gearmotor and optionally at least one of the two other rollers can be powered by a gearmotor.

The outlet and rotating means which is closer to the outlet can be adapted to allow a substantially uniform deposition of the substance at a predetermined thickness on a substrate to be disposed adjacently to the outlet. Adjustment of the distance between the rotating means which is closer to the outlet and the substrate can permit a substantially uniform deposition of the substance at a predetermined thickness.

The system can comprise an adjustment device which permits to control the distance between the rotating means which is closer to the outlet and the substrate. For example, such an adjustment device can comprise a threaded rod system. The system can also comprise further means for adjusting the relative distance between the system and the substrate to allow a substantially uniform deposition of the substance at a predetermined thickness. The rotating means which is closer to the outlet can be adapted to move essentially along an axis and to be adjusted so as to control the thickness of the substance to be spread.

The rotating means can comprise means for evacuating a liquid contained within the substance. The means for evacuating a liquid can comprise apertures defined within the rotating means, the apertures being adapted for evacuating the liquid. For example, at least one rotating means can be adapted to be rotated at a speed which is selected as a function of the nature of the substance to be spread.

The system can further comprise adjustment means to allow a substantially uniform deposition of the substance at a predetermined width.

According to another aspect of the invention, there is provided a feeding and spreading system for use in combination with an apparatus for electro-dewatering a substance or with a conveyor adapted to convey the substance. The system comprises:
a housing comprising an inlet and an outlet; and
at least two rotating means disposed in the housing and adjacently to the outlet, the rotating means being adapted to compress and move the substance substantially vertically towards the outlet, one of the rotating means being closer to the outlet than at least one other of the rotating means, the system being adapted to move the rotating means which is closer to the outlet essentially vertically and to adjust it so as to control the thickness of the substance to be spread through the outlet.

The rotating means closer to the outlet can be restricted to move along a vertical axis. For example, the rotating means can be substantially horizontally extending and can be rotated around a substantially horizontal rotation axis. The rotation axis of the rotating means which is closer to the outlet is lower than the rotation axis of the at least one other rotating means. The rotating means are adapted to receive therebetween the substance to be spread. For example, the rotating means can be rollers. The at least two rollers disposed adjacently to the outlet can be rotated at a same speed.

The system can further comprise two upper rollers disposed between the inlet and the rollers disposed adjacently to the outlet. The upper rollers can be substantially horizontally extending and are rotated around a substantially horizontal rotation axis. The upper rollers can be rotated substantially at a same speed and adapted to receive therebetween the substance and to compact it and to move it towards the rollers disposed adjacently to the outlet.

The system can also comprise adjustment means for adjusting the horizontal distance between the rollers disposed adjacently to the outlet, the adjustment means also permitting to adjust the horizontal distance between the upper rollers. The horizontal distance between the upper rollers can be greater than the horizontal distance between the rollers disposed adjacently to the outlet.

For example, the rollers and the upper rollers can define, therebetween, a volume which allows for compaction of the substance and to increase its density.

The outlet and the rotating means closer to the outlet can be adapted to allow a substantially uniform deposition of the substance at a predetermined thickness on the apparatus or conveyor to be disposed below the outlet. Adjustment of the distance between the rotating means which is closer to the outlet and a portion of the electro-dewatering apparatus or the conveyor can permit a substantially uniform deposition of the substance at a predetermined thickness.

The system can comprise an adjustment device which permits to control the distance between the rotating means which is closer to the outlet and the portion of the electro-dewatering apparatus or the conveyor. For example, the adjustment device can comprise a threaded rod system. The system can also comprise further means for adjusting the relative distance between the system and the portion of the electro-dewatering apparatus or the conveyor. The rotating means which is closer to the outlet can be adapted to move essentially vertically and to be adjusted so as to control the thickness of the substance to be spread through the outlet.

According to one embodiment, the roller closer to the outlet can be the rotating means which is adapted to be the closest or the farthest to an outlet of the electro-dewatering apparatus or the conveyor.

The system can further comprise adjustment means to allow a substantially uniform deposition of the substance at a predetermined width.

According to another aspect of the invention, there is provided a feeding and spreading system. The system comprises:
a housing adapted to receive a substance to be spread on a substrate via the feeding and spreading system, the housing comprising an inlet and an outlet, the outlet being adapted to be disposed adjacently to the substrate on which the substance is to be spread; and
at least two rotating means disposed adjacently to the outlet, the rotating means being adapted to compress and to move the substance downwardly to the outlet, the rotating means being each disposed at a different vertical distance from the outlet, the system being adapted to move the rotating means which is the closest to the outlet essentially vertically so as to control the thickness of the substance to be spread on the substrate through the outlet.

The outlet and rotating means which is the closest to the outlet can be adapted to allow a substantially uniform deposition of the substance on the substrate. The rotating means which is the closest to the outlet can be adapted to move essentially vertically and to be adjusted so as to control the thickness of the substance to be spread through the outlet on the substrate.

The rotating means can be substantially horizontally extending and can be rotated around a substantially horizontal rotation axis. The rotating means can be adapted to receive therebetween the substance to be spread on the substrate. For example, the rotating means can be rollers. The at least two rollers disposed adjacently to the outlet can be rotated at a same speed.

The system can further comprise two upper rollers disposed between the inlet and the rollers disposed adjacently to the outlet. The upper rollers can be substantially horizontally extending and be rotated around a substantially horizontal rotation axis. The upper rollers can be rotated substantially at a same speed and adapted to receive therebetween the substance to be spread in order to compact it and to move it towards the rollers disposed adjacently to the outlet. The system can further comprise adjustment means. The adjustment means can permit to adjust the horizontal distance between the rollers disposed adjacently to the outlet. The adjustment means can also permit to adjust the horizontal distance between the upper rollers. For example, the horizontal distance between the upper rollers can be greater than the horizontal distance between the rollers disposed adjacently to the outlet. The rollers and the upper rollers can define, therebetween, a volume which allows for compaction of the substance and to increase its density. The system can be adapted in such a manner that the system and the substrate are horizontally movable with respect to one another. The system can be horizontally movable or immovable.

Adjustment of the distance between the rotating means which is closest to the outlet and a portion of the substrate can permit a substantially uniform deposition of the substance at a predetermined thickness.

The system can also comprise an adjustment device which permits to control the distance between the rotating means which is the closest to the outlet and the substrate. The adjustment device can comprise a threaded rod system. The system can also further comprise means for adjusting the relative distance between the system and a portion of the substrate so as to control the thickness of the substance to be spread. The rotating means which is the closest to the outlet can be adapted to move essentially vertically and to be adjusted so as to control the thickness of the substance to be spread through the outlet.

The system can further comprise adjustment means to allow a substantially uniform deposition of the substance at a predetermined width.

According to another aspect of the invention, there is provided a method for spreading a substance on a substrate. The method comprises:
introducing the substance between cooperating rollers so as to compress the substance and move substantially downwardly the substance towards the substrate, and
horizontally moving the system and the substrate with respect to one another so as to spread the substance,
the method being characterized in that before introducing the substance between the rollers, the system is adjusted essentially along a vertical axis so as to select a position at which the substance to be spread will have a predetermined thickness.

The substrate can be a movable substrate adapted to be horizontally moved with respect to the system. For example, the movable substrate can be a conveyor.

Before introducing the substance between the rollers, the substance can be poured in a hopper and equalized over the entire length of the latter so as to uniformly spread it.

The system can be adjusted by essentially vertically moving one of the rollers in such a manner that the vertical distance between the roller and the substrate is smaller than the vertical distance between the other roller(s) and the substrate.

For example, the substance can be introduced between two upper cooperating rollers which are separated by a distance d1, and then introduced between two lower cooperating rollers separated by a distance d2. The distance d1 is greater than the distance d2, and the roller which is moved essentially along a vertical axis is one of the lower rollers. The upper and lower rollers can define, therebetween, a volume which allows for compaction of the substance and to increase its density.

The method can further comprise adjusting the distance between the cooperating rollers as a function of the nature and/or density of the substance to be treated.

Adjustment of the distance between one of the rollers and a portion of the substrate can permit a substantially uniform deposition of the substance at a predetermined thickness.

It was found that such systems and methods can offer several advantages. In fact, when one of such systems is combined for example with an electro-dewatering apparatus (PCT/CA2007/001052 filed on Jun. 13, 2007), the feeding and spreading system can allow for an appropriate compaction and a uniform spreading or distribution of the substance on a substrate (for example a conveyor). Such systems also permit to spread the substance at a predetermined thickness. When such an appropriate compaction is carried out, the substance to be treated can withstand a greater pressure. Moreover, in such a case, the substance to be treated allows for a better current conductibility since becoming less insulating for example by reducing the amount of air in it.

For example, when using such systems or methods, spreading of the substance is carried out uniformly and a cake of the substance to be treated having a uniform thickness over substantially the whole surface (width) of the substrate or conveyor can be obtained. Such a cake thus allows to carry out a uniform electro-dewatering process on the substance.

Such systems and methods are also effective for feeding with a substance to be treated, any apparatus, in a continuous manner. It can be also used in combination with an apparatus for drying a substance.

### BRIEF DESCRIPTION OF DRAWINGS

Further features and advantages of the invention will become more readily apparent from the following examples shown in the drawings wherein:

FIG. 1 is a perspective view of a spreading and feeding system according to one example;

FIG. 2 is a side view of the system shown in FIG. 1;

FIG. 3 is another side view of the system shown in FIG. 1;

FIG. 4 is a rear view of the system shown in FIG. 1;

FIG. 5 is a cross-section view taken along the line 5-5 in FIG. 4; and

FIG. 6 is a cross-section view of the system of FIG. 1 used in combination with a conveyor.

### DETAILED DESCRIPTION OF THE INVENTION

Further features and advantages of the invention will become more readily apparent from the following non-limiting specific embodiments.

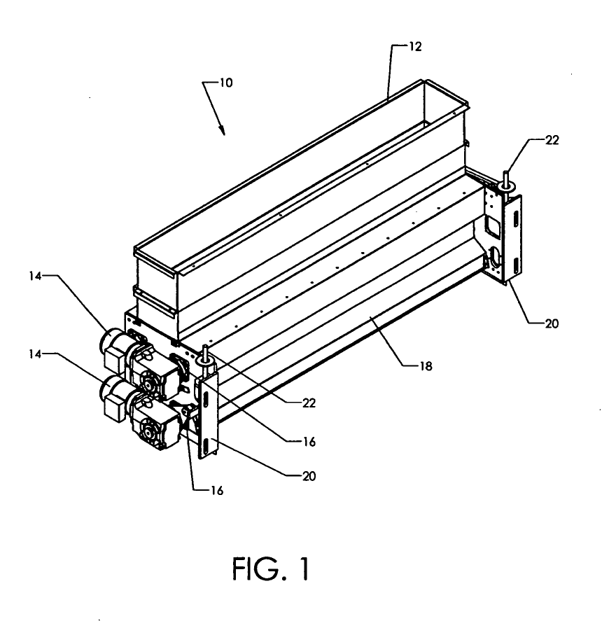

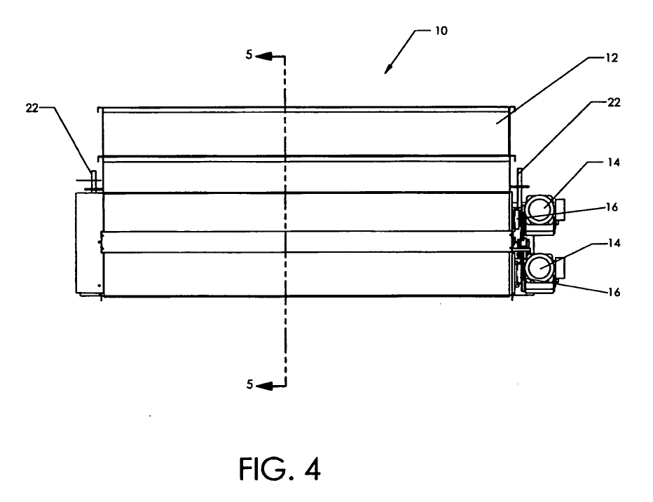

As shown in FIGS. 1 and 4, the system 10 comprises a housing such as a hopper 12 supported by two lateral walls 20. The lateral walls 20 support gearmotors 14. Interior wall 18 allows confining of the substance to be spread inside the system 10. An adjustment device 22 allows the vertical adjustment of the system. Such a device permits to adjust the vertical distance of the system 10 with respect to an apparatus or substrate disposed below, when the system is used in combination with such a device. For example, the adjustment device 22 can comprise a threaded rod system provided with a nut. Alternatively, lateral walls 20 can also allow fixation and adjustment of the system with respect to an apparatus or substrate. The device 22 can also comprise other adjustment means to adjust the distance between the system and the apparatus or substrate. Such means can be for example shims or an adjustable structure which supports the system 10, a pneumatic actuator, mechanical systems (hydraulic systems, screw systems or the like), or electrical systems). Gearmotors 14 and drive rollers (not shown) which are fixed on a flange bearing 16.

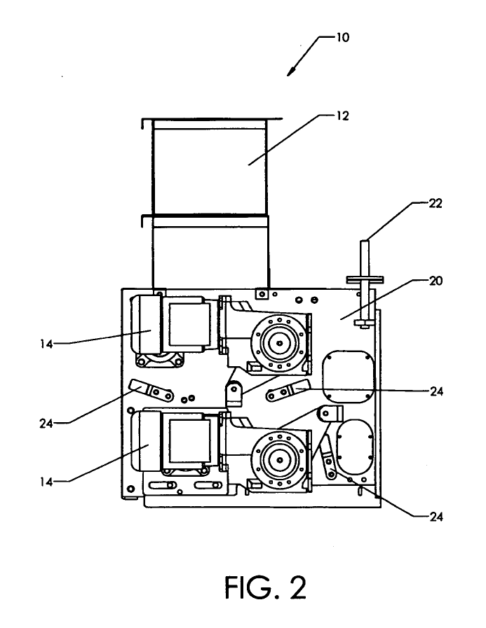

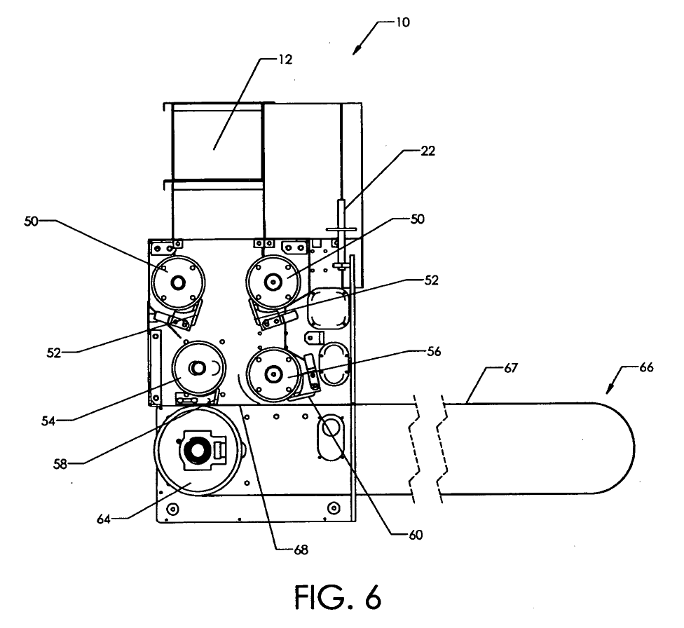

FIG. 2 shows that in the system 10, the hopper 12 is connected to the lateral wall 20, and that the two gearmotors 14 are connected to the wall 20. The system 10 also comprises scrapers adjustment devices 24 and the vertical adjustment device 22 which allows to adjust the height of the system 10 with respect to a substrate (not shown) i.e. the distance between the system 10 and the substrate. Such a substrate can be a movable substrate such as conveyor 66 shown in FIG. 6.

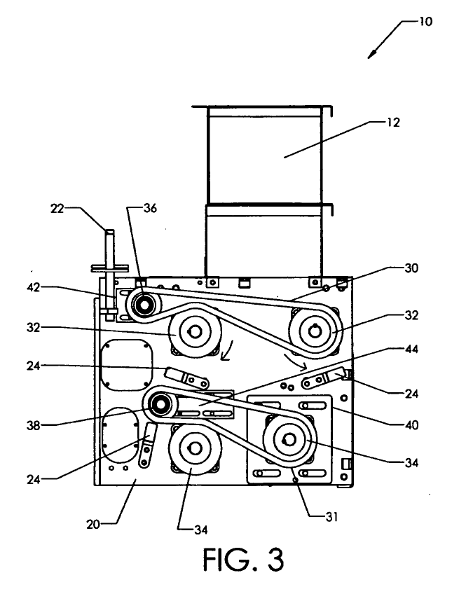

As shown in FIG. 3, the system 10 also comprises two upper sprocket wheels 32, two lower sprocket wheels 34, an upper sprocket wheel 36, a lower sprocket wheel 38. All these wheels are connected to the wall 20. The system 10 also comprises an horizontal adjustment device 42 of the upper sprocket wheel 36, an horizontal adjustment device 44 of the lower sprocket wheel 38 and an adjustment device 40 of a lower roller (not shown). An upper drive chain 30 passes through the sprocket wheels 32 and 36. The lower drive chain 31 passes through the sprocket wheels 34 and 38. The scrapers adjustment devices 24 permit to fix the scrapers (not shown) and to adjust them.

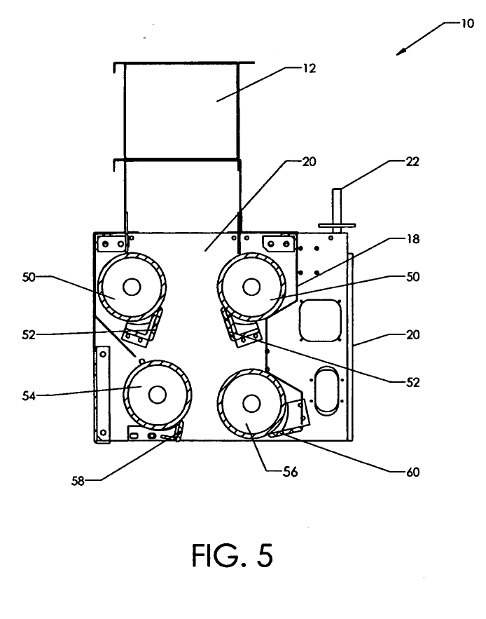

The adjustment device 40 allows the displacement of the roller 54 (shown in FIG. 5) and the adjustment of the distance between the lower rollers 54 and 56 (shown in FIG. 5). The roller 54 is rotatably mounted into device 40 which comprises bearing and a slot. Emplacement of the roller can be adjusted within the slot. The device 40 can be for example a take-up bearing system.

The adjustment device 44 allows fixation and adjustment of the sprocket wheel 38. The device 44 comprises a plate provided with oblong holes to be connected to the wall 20. This plate is adapted to support the wheel 38. The device 42 is similar to device 44.

In FIG. 5, the cross-section view taken along the line 5-5 of FIG. 4, shows two upper rollers 50, two upper scrapers 52, a lower roller 54, a lower scraper 58, a lower roller 56, a lower scraper 60. Such rollers are rotatably mounted inside wall 20. The interior wall 18 allows for the confinement of the substance inside the system 10. The lateral wall 20 permits to support the upper and lower rollers and the upper and lower scrapers, to confine the substance inside the system, and define the width of the substance to be spread. The wall 20 can thus act as an adjustment means to allow a substantially uniform deposition of the substance at a predetermined width.

As it can be seen in FIG. 6, the system 10 can be used in combination with a conveyor 66, which comprises a roller 64 and a conveying belt 67. The conveying belt 67 can be rigidified, for example, by a plate 68, which substantially reduces the risks of deformations, in order to obtain the desired thickness. FIG. 6 also shows, two upper rollers 50 and its scrapers 52 and two lower rollers 54 and 56 and their respective scrapers 58 and 60.

The system 10 permits a uniform spreading of a substance at a predetermined thickness substantially on the entire width of the conveying belt 67 (see FIG. 6). The conveying belt 67 can also comprise a lateral guide member (not shown) in order to contain the substance. Such a guide member can also permit to spread the substance according to a predetermined width.

In the upper section of the system 10, distributor means (not shown) can be provided so as to spread and equalize the substance substantially over the entire length of the hopper 12. This distributor means can be for example a screw or an oscillating system. The substance can be various types of solids such as biosolids, solids used in food processing or agri-food industries, sludges. The level of substance can be equalized as the matter is distributed substantially over the entire length of the hopper 12. The thickness of the substance uniformly deposited onto the conveying belt 67 is regulated by adjusting vertically the distance between the conveyor 66 and the lower roller 56 by means of the device 22. Alternatively, such an adjustment of the distance can be made by providing the roller 56 with an adjustment device similar to device 40 but that would permit to essentially vertically move the roller 56. Thus, instead of moving vertically the whole system 10, only the roller 56 can be moved so as to select the desired thickness. In accordance with another embodiment, it is possible to provide the system 10 with both devices i.e. a device 22 and a device similar to device 40 but that would permit to essentially vertically move the roller 56. According to the nature of the substance to be treated, a further adjustment can be done by changing the distance between rollers 54 and 56 by means of the device 40.

For example, the distance between the upper rollers (the two rollers 50) can be greater than the distance between the lower rollers (rollers 54 and 56). The upper and lower rollers have a double function: they drive the substance and also compress it. The volume in the central zone, defined by the upper and lower rollers, allows to compact the substance and to increase its density. For example, such a central zone can be comprised between the upper and lower rollers.

The external surface of the rollers can be a rough surface so as to permit a better feeding of the substance. Such surface finish reduces the slip between substance and the rollers. The drive of substance depends on the surface contact with the rollers. Speeds of upper and lower rollers can be selected according to the nature of the substance. The speed of the conveyor belt 67 can also be selected according to the nature of substance to be spread or deposited by the system 10. The speed of the rollers are controlled by gearmotors which are provided by drives.

When the substance is poured and equalized over the entire length of the hopper 12. The upper rollers 50 will compact and move the substance vertically towards the lower rollers 54 and 56. Such lower rollers will provide further compression of the substance and will move it towards the conveyor belt 67. The distance between roller 56 and conveyor 66 will permit to compress the substance and define the final thickness of the latter. The system 10 can operate continuously or as a batch process. It can also be automated by providing level sensors and drives. When the system 10 is used in combination with an apparatus, for example an apparatus for electro-dewatering such as defined PCT/CA2007/001052 filed on Jun. 13, 2007, lateral walls 20 permit fixation of the system to the apparatus. Lateral walls 20 are provided with oblong holes allowing the vertical guides of the system and the adjustment of the distance relative to the conveyor i.e. between the system and the conveyor. The distance defined between the system and the conveyor can also be adjusted by the adjustment device 22 by tightening the nut of the threaded rod system. The two adjustment devices can be used simultaneously.

This system can be used for any application which needs feeding and/or a spreading of a substance on a predetermined thickness. For example, it can be used in combination with an apparatus for substance electro-dewatering or with any apparatuses which require a substance conditioning and spreading at a predetermined thickness.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

1. A system for spreading a substance, the system comprising:
a housing adapted to receive said substance and comprising an inlet and an outlet; and
at least two rollers disposed in said housing and adjacently to said outlet, said rollers being adapted to compress and move said substance to said outlet, one of said rollers being closer to the outlet than at least one other of said rollers, said system being adapted to move said roller which is closer to the outlet essentially along an axis and to adjust it so as to control the thickness of the substance to be spread through the outlet.

2. The system of claim 1, wherein said rotating means closer to the outlet is restricted to move along said axis.

3-4. (canceled)

5. The system of claim 1, wherein said at least two rollers disposed adjacently to said outlet are rotated at a same speed.

6. The system of claim 1, wherein said system further comprises at least two other rollers disposed between said inlet and said rollers disposed adjacently to said outlet, said at least two other rollers being rotated substantially at a same speed and adapted to receive therebetween the substance to be spread through said outlet.

7. The system of claim 6, further comprising adjustment means, said adjustment means permitting to adjust the distance between two adjacent rollers disposed so as to control the pressure applied to the substance passing therebetween.

8. The system of claim 7, wherein the distance between said at least two other rollers is greater than the distance between said rollers disposed adjacently to said outlet.

9. The system of claim 6, wherein said rollers and said other rollers define, therebetween, a volume which allows for compaction of the substance and to increase its density.

10. The system of claim 1, wherein each of said rollers is rotated according to a predetermined speed.

11. The system of claim 6, wherein said at least two rollers are rotated according to a predetermined speed and said at least two other rollers are rotated to another predetermined speed.

12-13. (canceled)

14. The system of claim 1, wherein said outlet and roller which is closer to the outlet are adapted to allow a substantially uniform deposition of said substance at a predetermined thickness on a substrate to be disposed adjacently to said outlet.

15. (canceled)

16. The system of claim 1, wherein said system comprises an adjustment device which permits to control the distance between said roller which is closer to the outlet and said substrate.

17. The system of claim 16, wherein said adjustment device comprises a threaded rod system.

18-19. (canceled)

20. The system of claim 1, wherein said rollers comprise apertures for evacuating a liquid contained within said substance.

21. (canceled)

22. The system of claim 1, wherein at least one roller is adapted to be rotated at a speed which is selected as a function of the nature of the substance to be spread.

23. (canceled)

24. The system of claim 1 further comprising a conveyor adapted to convey said substance to an apparatus for electro-dewatering said substance.

25. The system of claim 1, wherein said roller closer to the outlet is restricted to move along a vertical axis.

26. The system of claim 1, wherein said rollers are substantially horizontally extending and are rotated around a substantially horizontal rotation axis, the rotation axis of said roller which is closer to the outlet is lower than the rotation axis of the at least one other roller, said rollers being adapted to receive therebetween the substance to be spread.

27-41. (canceled)

42. A feeding and spreading system, said system comprising:
a housing adapted to receive a substance to be spread on a substrate via said feeding and spreading system, said housing comprising an inlet and an outlet, said outlet being adapted to be disposed adjacently to said substrate on which said substance is to be spread; and
at least two rollers disposed adjacently to said outlet, said rollers being adapted to compress and to move said substance downwardly to said outlet, said rollers being each disposed at a different vertical distance from said outlet, said system being adapted to move said roller which is the closest to the outlet essentially vertically so as to control the thickness of the substance to be spread on said substrate through said outlet.

43-60. (canceled)

61. A method for spreading a substance on a substrate, said method comprising:
introducing said substance between cooperating rollers so as to compress said substance and move substantially downwardly said substance towards said substrate, and horizontally moving said system and said substrate with respect to one another so as to spread said substance, the method being characterized in that before introducing the substance between said rollers, said system is adjusted essentially along a vertical axis so as to select a position at which the substance to be spread will have a predetermined thickness.

62. The method of claim 61, wherein said substrate is a movable substrate adapted to be horizontally moved with respect to said system, and wherein said substrate is optionally moved at a speed which is selected as a function of the nature of the substance to be spread.

63-69. (canceled)
